(19) United States
(12) Patent Application Publication
(10) Pub. No.: US 2011/0163258 A1
(43) Pub. Date: Jul. 7, 2011

(54) MIXTURES OF ALKALI METAL POLYSULFIDES

(75) Inventors: Fabian Seeler, Dossenheim (DE); Felix Major, Mannheim (DE); Kerstin Schierle-Arndt, Zwingenberg (DE); Jürgen Wortmann, Limburgerhof (DE); Martin Gärtner, Worms (DE); Michael Lutz, Speyer (DE); Stephan Maurer, Neustadt-Gimmeldingen (DE); Otto Machhammer, Mannheim (DE); Günther Huber, Ludwigshafen (DE); Hans-Josef Sterzel, Dannstadt-Schauernheim (DE)

(73) Assignee: BASF SE, Ludwigshafen (DE)

(21) Appl. No.: 12/979,431

(22) Filed: Dec. 28, 2010

Related U.S. Application Data
(60) Provisional application No. 61/306,982, filed on Feb. 23, 2010.

(30) Foreign Application Priority Data
Jan. 5, 2010 (DE) 102010004063.0

(51) Int. Cl. C09K 5/00

(52) U.S. Cl. 252/71

(57) ABSTRACT

The present invention relates to mixtures of alkali metal polysulfides and to mixtures of alkali metal polysulfides and alkali metal thiocyanates, to processes for preparation thereof, to the use thereof as heat transfer or heat storage fluids, and to heat transfer or heat storage fluids which comprise the mixtures of alkali metal polysulfides or the mixtures of alkali metal polysulfides and alkali metal thiocyanates.

The present invention relates to mixtures of alkali metal polysulfides and to mixtures of alkali metal polysulfides and alkali metal thiocyanates, to processes for preparation thereof, to the use thereof as heat transfer or heat storage fluids, and to heat transfer or heat storage fluids which comprise the mixtures of alkali metal polysulfides or the mixtures of alkali metal polysulfides and alkali metal thiocyanates.

Fluids for transferring thermal energy are used in various fields of industry. In internal combustion engines, mixtures of water and ethylene glycol convey the heat of combustion into the radiator. Similar mixtures convey the heat from solar roof collectors into heat stores. In the chemical industry, they convey the heat from electrical or fossil-fuel heating systems to chemical reactors or out of the latter to cooling apparatus.

According to the field of use, the profile of requirements for heat transfer or heat storage fluids varies very greatly, and therefore a multitude of fluids is used in practice. The fluids should be liquid and have low viscosities at room temperature or even lower temperatures. For higher use temperatures, water is no longer an option; its vapor pressure would become too great. Therefore, hydrocarbon-based mineral oils are used up to approximately 320° C., and synthetic aromatics-containing oils or silicone oils for temperatures up to 400° C. (VDI Wärmeatlas, VDI-Gesellschaft Verfahrenstechnik and Chemieingenieurwesen, Springer Verlag Berlin Heidelberg 2006).

A new challenge for heat transfer fluids is that of thermal solar power plants, which generate electrical power on a large scale (Butscher, R., Bild der Wissenschaft 2009, 3, pages 84 to 92). To date, such power plants have been built with an installed power of a few hundreds of MW, and many others are planned, especially in Spain, but also in North Africa and the USA. The solar radiation is focused, for example, by means of parabolically shaped mirror troughs into the focus line of the mirrors. At the focus line is a metal tube present within a glass tube to prevent heat losses, the space between the concentric tubes being evacuated. A heat transfer fluid flows through the metal tube. Currently, a mixture of diphenyl ether and diphenyl is used here. The heat transfer is heated to a maximum of 400° C., and is used to operate a steam generator in which water is evaporated. This steam drives a turbine and this in turn drives the generator as in a conventional power plant. Thus, peak efficiencies of approximately 30 percent are achieved, based on the energy content of the solar irradiation. The efficiency of the steam turbines at this entrance temperature is approximately 37 percent.

Both constituents of the mixture of diphenyl ether and diphenyl used as a heat transfer boil at approximately 256° C. under standard pressure. The melting point of diphenyl is 68-72° C., and that of diphenyl ether 26-39° C. The mixing of the two substances lowers the melting point to 12° C. The mixture of the two substances can be used up to a maximum of 400° C.; at higher temperatures, decomposition occurs. The steam pressure is about 10 bar at this temperature, a pressure which is still tolerable in industry.

In order to obtain higher turbine efficiencies than 37 percent, higher steam inlet temperatures are necessary. The efficiency of a steam turbine rises with the turbine inlet temperature. Modern fossil fuel-fired power plants work with steam inlet temperatures up to 650° C. and thus achieve efficiencies around 45%. It would be technically entirely possible, to heat the heat transfer fluid in the focus line of the mirrors to temperatures around 650° C. and thus likewise to achieve such high efficiencies; this, however, is prevented by the limited thermal stability of the currently used heat transfer fluid.

Higher temperatures than in parabolic trough power plants can be achieved in solar tower power plants, in which one tower is surrounded by mirrors which focus the sunlight onto a receiver in the upper part of the tower. In this receiver, a heat transfer is heated, which is utilized to raise steam by means of a heat exchanger and to operate a turbine. In tower power plants (Solar II, Calif.), a mixture of sodium nitrate (NaNO₃) and potassium nitrate (KNO₃) (60:40) has already been used as a heat transfer. This mixture can be used up to 550° C. without any problem, but has a very high melting point of 240° C.

There are to date no known organic substances which permanently withstand temperatures above 400° C. without decomposition. Some dimethylsilicone- or diphenylsilicone-based oils can likewise be used up to temperatures of 400° C. or even at somewhat higher temperatures. However, the very high cost thereof opposes the use thereof in thermal solar power plants.

Another option is the use, known from nuclear technology, of liquid sodium or sodium-potassium alloy as a heat transfer. However, the preparation of these metals is very expensive, and they react with traces of water to give hydrogen gas, which constitutes a safety challenge.

In addition, low-melting solder metals, for example Wood's metal (Bi—Pb—Cd—Sn alloy, melting point approximately 75° C.), are known. However, the very high specific weight opposes use as a heat transfer fluid.

Further possible high-temperature heat transfers based on sulfur have been proposed, which is used, for example, in a mixture with smaller amounts of selenium and/or tellurium (WO 2005/071037). Liquid sulfur is problematic as a heat transfer since it has high viscosity in the range of 150 to 200° C. and cannot be pumped in this form. The viscosity can be reduced by additives such as bromine or iodine (U.S. Pat. No. 4,335,578), but they are highly corrosive.

It is technically also possible to use water under correspondingly high pressure. This is opposed, however, by the extremely high vapor pressure of more than 270 bar at temperatures of more than 500° C., which would make the many kilometers of pipelines in a thermal solar power plant uneconomically expensive. The steam itself, as a heat transfer, is disadvantageous owing to its comparatively low thermal conductivity and the low heat capacity per unit volume compared to a liquid.

A further option is the use of inorganic salt melts as heat transfer fluid. Such salt melts are state of the art in processes which work at high temperatures. The eutectic mixture of potassium nitrate, sodium nitrate and sodium nitrite has a melting point of 146° C. and is commercially available. However, the upper use temperature is limited to 450° C., since considerable decomposition of the nitrite to nitrous gases, alkali metal oxides and elemental nitrogen takes place above this temperature. The eutectic mixture of sodium nitrate and potassium nitrate can be used up to temperatures of 600° C. However, the use of this mixture as a heat transfer fluid in solar power plants is problematic owing to the high melting point of approx. 220° C. Lowering of the temperature below the melting point, for example in the night or during periods of low solar irradiation, would result in solidification of the salt in the pipelines. This has to be prevented because local stresses would arise in the course of remelting, which would result in damage to the plant. Antifreeze protection in the form of trace heating would be conceivable, but is technically very difficult to implement and additionally expensive for such high temperatures. The melting point of the mixture of sodium nitrate and potassium nitrate can be lowered by adding lithium nitrate or calcium nitrate (Bradshaw, R. W., Meeker, D. E., Solar Energy Materials 1990, Vol. 21, page 51 to 60). However, mixtures with lithium nitrate are uneconomic owing to the high cost, while the presence of calcium promotes the decomposition of the nitrate to nitrite and oxygen, and hence the upper application temperature is lowered even further with rising calcium content.

Furthermore, the use of metal halides as a heat transfer fluid would be possible. The problem arises here that halogenated fluids, especially at elevated temperatures, often cause corrosion problems for the metallic materials to be used.

Mixtures of alkali metal polysulfides, especially of sodium and potassium polysulfides, should theoretically have low melting points and could be usable at temperatures of up to 500° C. and higher. The phase diagram for the ternary sodium sulfide-potassium sulfide-sulfur system should, according to calculations, have invariant points with low melting temperatures for the compositions K_{0.84}Na_{0.26}S_{3.61} (78° C.), K_{0.77}Na_{0.23}S_{3.75} (73° C.) and K_{0.79}Na_{0.21}S_{3.95} (83° C.) (Lindberg, D., Backman, R., Hupa, M., Chartrand, P., J. Chem. Therm. 2006, vol. 38, pages 900 to 915). There are no experimental data for this ternary system. In the potassium sulfide-sulfur system, the melting point can be lowered to approximately 120° C. (Sangster, J., Pelton, A. D., J. Phase Equil. 1997, vol. 18, page 82). One disadvantage of the alkali metal polysulfides is the relatively high viscosity thereof in the molten state, especially that of sodium polysulfides (Cleaver, B., Davis, A. J., Electrochimica Acta 1973, vol. 18, pages 727 to 731).

DE 3824517 describes the use of mixtures of the alkali metal thiocyanates as heat transfer fluids, especially of potassium thiocyanate and sodium thiocyanate. Potassium thiocyanate melts at 173° C., sodium thiocyanate at 310° C. The eutectic mixture of the two salts with a ratio of 73 mol % of potassium thiocyanate to 27 mol % of sodium thiocyanate has a melting point around 130° C. The melt is of low viscosity and hence pumpable without increased energy expenditure.

One disadvantage of the alkali metal thiocyanates is that they already begin to decompose at temperatures above 450° C. With the exclusion of sulfur, the higher-melting alkali metal cyanides are formed (Gmelins Handbuch der Anorganischen Chemie 1938, vol. 22, page 899).

The melting point of the alkali metal thiocyanates can be lowered further by adding further salts. Especially the addition of nitrites or nitrates lowers the melting point. However, the addition of the oxidizing nitrites or nitrates at elevated temperature causes an explosive decomposition, which can additionally be accelerated by any dissolved heavy metal traces. The use of such mixtures for industrial use is therefore ruled out.

A further problem arises from the fact that the aim is to operate a solar power plant continuously. This can be achieved by storing heat during periods of high solar irradiation, which can be utilized for power production after sunset or during phases of poor weather. Heat can be stored directly by storing the heated heat transfer medium in well-insulated reservoir tanks, or indirectly by transferring heat to another storage medium.

The indirect method is implemented in the 50 MW Andasol I power plant in Spain, where approx. 28 000 t of a melt of sodium nitrate and potassium nitrate (60:40; wt.-%) are used. The melt is pumped during the periods of solar irradiation from a colder tank (approximately 280° C.) through an oil-salt heat exchanger into a hotter tank, in the course of which it is heated to about 380° C. In periods of low solar irradiation and at night, the power plant can be run under full load with the store fully charged for about 7.5 h (www.solarmillennium.de/upload/Download/Technologie/Andasol1-3deutsch.pdf). However, it would be advantageous also to use the heat transfer fluid as a storage fluid, since it would thus be possible to dispense with the corresponding oil-salt heat exchangers. This is not being considered to date owing to the high vapor pressure of the oil and the high cost compared to the nitrate salts.

It is an object of the invention to provide a readily available, improved heat transfer and heat storage fluid. The fluid should be usable at higher temperatures than 400° C., preferably above 500° C. At the same time, the melting point should be at a minimum, preferably below 200° C. The liquid should additionally have a technically controllable, minimal vapor pressure, preferably less than 10 bar.

The object is achieved in accordance with the invention by mixtures of alkali metal polysulfides.

The invention therefore provides mixtures of alkali metal polysulfides of the general formula

(M¹ₓM²₍₁₋ₓ₎)₂S_{y}

where M¹, M²=Li, Na, K, Rb, Cs, and M¹ is not the same as M², and 0.05≦x≦0.95 and 2.0≦y≦6.0.

In a preferred embodiment of the invention, M¹=K, M²=Na, 0.20≦x≦0.95 and 3.0≦y≦6.0.

In a further preferred embodiment of the invention, 0.20≦x≦0.95. In a particularly preferred embodiment of the invention, 0.50≦x≦0.90.

In a further preferred embodiment of the invention, 3.0≦y≦6.0. In a particularly preferred embodiment of the invention, y=4.0, 5.0 or 6.0.

In a particularly preferred embodiment of the invention, M¹=K, M²=Na, 0.20≦x≦0.95 and 3.0≦y≦6.0.

In a very particularly preferred embodiment of the invention, M¹=K, M²=Na, 0.50≦x≦0.90 and y=4.0, 5.0 or 6.0.

A further embodiment relates to alkali polysulfides of composition (K₁₋ₓ₎Naₓ)₂ S_{z}, with x=0 up to 1 and z=2.3 up to 3.5, preferably x=0.5 up to 0.7 and z=2.4 up to 2.9.

A further embodiment relates to alkali polysulfides (Na_{0.5-0.65}K_{0.5-0.35})₂S_{2.4-2.6}, or such having the composition (Na_{0.6}K_{0.4})₂ S_{2.6}.

The inventive mixtures are notable for particularly low melting points. In a preferred embodiment of the invention, the melting point of the inventive mixture is below 200° C., and in a particularly preferred embodiment below 160° C.

The inventive mixtures have a high thermal stability. In a preferred embodiment of the invention, the inventive mixtures are stable up to a temperature of 450° C., in a particularly preferred embodiment up to a temperature of 500° C., and in a very particularly preferred embodiment even at temperatures above 500° C.

In a preferred embodiment of the invention, the inventive mixtures at 500° C. have a vapor pressure of below 5 bar, more preferably of below 2 bar.

The preparation of alkali metal polysulfides is known and can be effected, for example, by reaction of alkali metal sulfides with sulfur. One alternative is the direct reaction of alkali metals with sulfur, as described in U.S. Pat. No. 4,640,832 for sodium. The reaction of alkali metals in liquid ammonia with sulfur has likewise been described. A further synthesis option is the reaction of alkali metal hydrogensulfides or alkali metal sulfides with sulfur in alcoholic solution.

The invention further provides a process for preparing the inventive mixtures of alkali metal polysulfides, which comprises heating corresponding alkali metal sulfides with sulfur or corresponding alkali metal polysulfides with or without sulfur, under protective gas or under reduced pressure.

In a preferred embodiment of the process according to the invention, the starting materials are heated to at least 400° C. for at least 0.5 hour.

Suitable protective gases are noble gases, preferably argon, or nitrogen.

The invention further provides a process for preparing the inventive mixtures of alkali metal polysulfides, which comprises reacting a solution of corresponding alkali metals in liquid ammonia with sulfur under protective gas.

The invention further provides for the use of the inventive mixtures of alkali metal polysulfides as heat transfer or heat storage fluids.

In a preferred embodiment of the invention, the inventive mixtures of alkali metal polysulfides are used with exclusion of air and moisture, preferably in a closed system of, for example, pipelines, pumps, control units and vessels, in order to prevent hydrolytic reactions or the oxidation of the heat transfer or heat storage fluid in the course of operation.

The invention further provides heat transfer or heat storage fluids which comprise the inventive mixtures of alkali metal polysulfides.

The field of application of the inventive mixtures of alkali metal polysulfides can be extended further when they are mixed with alkali metal thiocyanates.

The invention further provides mixtures of alkali metal polysulfides and alkali metal thiocyanates of the general formula

((M¹ₓM²₍₁₋ₓ₎)₂S_{y})ₘ(M³_{z}M⁴_{(1-z)}SCN)₍₁₋ₘ₎

where M¹, M². M³, M⁴=Li, Na, K, Rb, Cs, and M¹ is not the same as M², M³ is not the same as M⁴, and 0.05≦x≦1, 0.05≦z≦1, 2.0≦y≦6.0, and m is the molar proportion, where 0.05≦m≦0.95.

In a preferred embodiment of the invention, M¹ and M³=K and M² and M⁴=Na.

In a further preferred embodiment of the invention, 0.20≦x≦1. In a particularly preferred embodiment of the invention, 0.50≦x≦1.

In a further preferred embodiment of the invention, 3.0≦y≦6.0. In a particularly preferred embodiment of the invention, y=4.0, 5.0 or 6.0.

In a further preferred embodiment of the invention, 0.20≦z≦1. In a particularly preferred embodiment of the invention 0.50≦z≦1.

In a further preferred embodiment of the invention, 0.20≦m≦0.80. In a particularly preferred embodiment of the invention, 0.33≦m≦0.80.

In a particularly preferred embodiment of the invention, M¹ and M³=K, M² and M⁴=Na, 0.20≦x≦1, 0.20≦z≦0.95, 3.0≦y≦6.0 and 0.20≦m≦0.95.

In a very particularly preferred embodiment of the invention, M¹ and M³=K, M² and M⁴=Na, 0.50≦x≦1, 0.50≦z≦0.95, y=4.0, 5.0 or 6.0 and 0.33≦m≦0.80.

In a further particularly preferred embodiment of the invention, M¹ and M³=K, x=1, z=1, y=4.0, 5.0 or 6.0 and 0.33≦m≦0.80.

In a further particularly preferred embodiment of the invention, M¹ and M³=K, x=1, z=1, y=4 and m=0.5.

In a further particularly preferred embodiment of the invention, M¹ and M³=K, x=1, z=1, y=5 and m=0.5.

In a further particularly preferred embodiment of the invention, M¹ and M³=K, x=1, z=1, y=6 and m=0.5.

It has been found that, surprisingly, the inventive mixtures of alkali metal polysulfides and alkali metal thiocyanates are more thermally stable than the alkali metal thiocyanates alone. In addition. the viscosity of the inventive mixtures of alkali metal polysulfides and alkali metal thiocyanates is lower than that of the alkali metal polysulfide mixtures without alkali metal thiocyanates.

The preparation of alkali metal thiocyanates is known and is performed on the industrial scale.

The invention further provides a process for preparing the inventive mixtures of alkali metal polysulfides and alkali metal thiocyanates by co-melting alkali metal polysulfides and alkali metal thiocyanates. The process can also be performed while stirring the melt.

The inventive mixtures of alkali metal polysulfides and alkali metal thiocyanates are generally suitable for high-temperature applications which require a heat transfer composition with a broad liquid temperature range.

The invention further provides for the use of the inventive mixtures of alkali metal polysulfides and alkali metal thiocyanates as heat transfer or heat storage fluids.

In a preferred embodiment of the invention, the inventive mixtures of alkali metal polysulfides and alkali metal thiocyanates are used with exclusion of air and moisture, preferably in a closed system of, for example, pipelines, pumps, control units and vessels, in order to avoid hydrolytic reactions or the oxidation of the heat transfer or heat storage fluid in the course of operation.

The invention further provides heat transfer or heat storage fluids which comprise the inventive mixtures of alkali metal polysulfides and alkali metal thiocyanates.

### EXAMPLES

1. Synthesis of sodium-potassium polysulfides (KₓNa₁₋ₓ)₂S_{y}

a) By melting mixtures of alkali metal polysulfides and sulfur

The K₂S₃ and Na₂S₄ starting materials were prepared by literature methods.

Synthesis of Na_{0.464}K_{1.536}S_{3.745}

3.51 g of K₂S₃, 0.43 g of sulfur and 1.06 g of Na₂Sₐ were heated to 400° C. in a closed, evacuated quartz glass ampoule for 30 minutes, and the melt was then cooled to room temperature. The ampoule was opened in an argon glovebox and the red to reddish-yellow solid was pulverized by pestling (quantitative yield). The solid melts in the range of 151-157° C.

Synthesis of Na_{0.42}K_{1.58}S_{3.80}

3.65 g of K₂S₃, 0.49 g of sulfur and 0.95 g of Na₂S₄ were heated to 400° C. in a closed, evacuated quartz glass ampoule for 30 minutes, and the melt was then cooled to room temperature. The ampoule was opened in an argon glovebox and the red to reddish-yellow solid was pulverized by pestling (quantitative yield). The solid melts in the range of 158-167° C.

Synthesis of Na_{0.325}K_{1.675}S_{3.61}

3.87 g of K₂S₃, 0.38 g of sulfur and 0.75 g of Na₂S₄ were heated to 400° C. in a closed, evacuated quartz glass ampoule for 30 minutes, and the melt was then cooled to room temperature. The ampoule was opened in an argon glovebox and the red to reddish-yellow solid was pulverized by pestling (quantitative yield). The solid melts in the range of 157-163° C.

b) By reaction of alkali metals with sulfur in liquid ammonia

Synthesis of Na_{0.46}K_{1.54}S_{3.75}

The synthesis was carried out under an atmosphere of argon with the aid of Schlenk and glovebox techniques. 63.6 g (1.98 mol) of sulfur were initially charged in liquid ammonia at −30° C. in a glass flask. Subsequently, a blue solution of 5.50 g (0.24 mol) of sodium metal and 32.0 g (0.81 mol) of potassium metal in approx. 800 ml of liquid ammonia (−30° C.) were added dropwise while stirring. The resulting mixture was warmed to room temperature and stirred until the ammonia had evaporated. The resulting orange solid was subsequently freed of ammonia residues at 150° C. under reduced pressure (approx. 1 mbar). The solid melts in the range of 166-169° C.

Synthesis of Na_{0.23}K_{1.77}S_{3.75}

The synthesis was carried out under an atmosphere of argon with the aid of Schlenk and glovebox techniques. 43.0 g (1.34 mol) of sulfur were initially charged in liquid ammonia at −30° C. in a glass flask. Subsequently, a blue solution of 1.82 g (0.079 mol) of sodium metal and 24.9 g (0.63 mol) of potassium metal in approx. 800 ml of liquid ammonia (−30° C.) were added dropwise while stirring. The resulting mixture was warmed to room temperature and stirred until the ammonia had evaporated. The resulting orange solid was subsequently freed of ammonia residues at 150° C. under reduced pressure (approx. 1 mbar). The solid melts in the range of 165-166° C.

2. Synthesis and properties of mixtures of (KₓNa₁₋ₓ)₂S_{y} with alkali metal thiocyanates

a) Synthesis

Method 1:

Corresponding amounts of potassium polysulfide (K₂Sₓ) or potassium sodium polysulfide ((KₓNa₁₋ₓ)₂S_{y}) and potassium thiocyanate (KSCN) were heated to 400° C. in a closed, evacuated quartz glass ampoule for 30 minutes, and the melt was then cooled to room temperature. The ampoule was opened in an argon glovebox, and the fusion product was pulverized by pestling. This afforded orange solids, the melting ranges of which are shown in tab. 1.

Method 2:

Corresponding amounts of potassium polysulfide (K₂Sₓ) or potassium sodium polysulfide ((KₓNa₁₋ₓ)₂S_{y}) and potassium thiocyanate (KSCN) were mixed and heated to 180° C. in a glass flask under an argon atmosphere. The mixture was stirred until a homogeneous melt had formed, and then cooled to room temperature. This afforded orange solids, the melting ranges of which were identical to those of the solids prepared according to method 1 (cf. tab. 1).

TABLE 1

| | Melting range |
|---|---|
| Composition | [° C.] |
| (K₂S₄)_{0.67}(KSCN)_{0.33} | 123-125 |
| (K₂S₄)_{0.50}(KSCN)_{0.50} | 110-112 |
| (K₂S₄)_{0.33}(KSCN)_{0.67} | 128-130 |
| (K₂S₅)_{0.50}(KSCN)_{0.50} | 150-158 |
| (K₂S₆)_{0.50}(KSCN)_{0.50} | 146-153 |
| (Na_{0.46}K_{1.54}S_{3.75})_{0.50}(KSCN)_{0.50} | 92-100 |
| (Na_{0.46}K_{1.54}S_{3.75})_{0.45}(KSCN)_{0.55} | 94-110 |
| (Na_{0.23}K_{1.77}S_{3.75})_{0.67}(KSCN)_{0.33} | 100-108 |
| (Na_{0.23}K_{1.77}S_{3.75})_{0.53}(KSCN)_{0.47} | 98-102 |
| (Na_{0.23}K_{1.77}S_{3.75})_{0.50}(KSCN)_{0.50} | 82-96 |
| (Na_{0.23}K_{1.77}S_{3.75})_{0.48}(KSCN)_{0.52} | 80-90 |
| (Na_{0.23}K_{1.77}S_{3.75})_{0.33}(KSCN)_{0.67} | 80-96 |

b) Viscosity

The viscosity of the melts was determined by means of rotational viscometry.

TABLE 2

| | Viscosity | |
|---|---|---|
| | [mPa * s] | |
| Composition | 160° C. | 180° C. |
| K₂S₄ | 1000 | 390 |
| (K₂S₄)_{0.50}(KSCN)_{0.50} | 235 | 113 |
| (K₂S₄)_{0.33}(KSCN)_{0.67} | 93 | 46 |
| Na_{0.46}K_{1.54}S_{3.75} | 8400 | 780 |
| (Na_{0.46}K_{1.54}S_{3.75})_{0.47}(KSCN)_{0.53} | 229 | 110 |
| (Na_{0.46}K_{1.54}S_{3.75})_{0.33}(KSCN)_{0.67} | 103 | 59 |
| Na_{0.23}K_{1.77}S_{3.75} | 2388 | 752 |
| (Na_{0.23}K_{1.77}S_{3.75})_{0.53}(KSCN)_{0.47} | 106 | 57 |
| (Na_{0.23}K_{1.77}S_{3.75})_{0.50}(KSCN)_{0.50} | 109 | 59 |
| (Na_{0.23}K_{1.77}S_{3.75})_{0.48}(KSCN)_{0.52} | 96 | 55 |
| (Na_{0.23}K_{1.77}S_{3.75})_{0.33}(KSCN)_{0.67} | 47 | 28 |

c) Thermal Stability

The examination of thermal stability was examined using the mixtures (K₂S₄)_{0.5}(KSCN)_{0.5} (melting range 110-112° C.), (K₂S₅)_{0.5}(KSCN)_{0.5}(melting range 150-158° C.) and (K₂S₆)_{0.5}(KSCN)_{0.5} (melting range 146-153° C.).

Stability at 400° C.:

3 g of a mixture of the composition (K₂S₄)_{0.5}(KSCN)_{0.5} were stored at 400° C. in an evacuated quartz glass ampoule for 28 days. The melting range of the mixture was unchanged.

3 g of a mixture of the composition (K₂S₅)_{0.5}(KSCN)_{0.5} were stored at 400° C. in an evecuated quartz glass ampoule for 28 days. The melting range of the mixture was unchanged.

3 g of a mixture of the composition (K₂S₆)_{0.5}(KSCN)_{0.5} were stored at 400° C. in an evacuated quartz glass ampoule for 28 days. The melting range of the mixture was unchanged.

Stability at 450° C.:

3 g of a mixture of the composition (K₂S₄)_{0.5}(KSCN)_{0.5} were stored at 450° C. in an evacuated quartz glass ampoule for 28 days. The melting range of the mixture was unchanged.

3 g of a mixture of the composition (K₂S₅)_{0.5}(KSCN)_{0.5} were stored at 450° C. in an evacuated quartz glass ampoule for 28 days. The melting range of the mixture was unchanged.

3 g of a mixture of the composition (K₂S₆)_{0.5}(KSCN)_{0.5} were stored at 450° C. in an evacuated quartz glass ampoule for 28 days. The melting range of the mixture was unchanged.

Stability at 500° C.:

3 g of a mixture of the composition (K₂S₄)_{0.5}(KSCN)_{0.5} were stored at 500° C. in an evacuated quartz glass ampoule for 28 days. The melting range of the mixture was unchanged.

3 g of a mixture of the composition (K₂S₅)_{0.5}(KSCN)_{0.5} were stored at 500° C. in an evacuated quartz glass ampoule for 28 days. The melting range of the mixture was unchanged.

3 g of a mixture of the composition (K₂S₆)_{0.5}(KSCN)_{0.5} were stored at 500° C. in an evacuated quartz glass ampoule for 28 days. The melting range of the mixture was unchanged.

Stability at 600° C.:

3 g of a mixture of the composition (K₂S₄)_{0.5}(KSCN)_{0.5} were stored at 600° C. in an evacuated quartz glass ampoule for 28 days. The melting range of the mixture was unchanged.

3 g of a mixture of the composition (K₂S₅)_{0.5}(KSCN)_{0.5} were stored at 600° C. in an evacuated quartz glass ampoule for 28 days. The melting range of the mixture was unchanged.

3 g of a mixture of the composition (K₂S₆)_{0.5}(KSCN)_{0.5} were stored at 600° C. in an evacuated quartz glass ampoule for 28 days. The melting range of the mixture was unchanged.

1. A mixture of alkali metal polysulfides of the general formula
(M¹ₓM²₍₁₋ₓ₎)₂S_{y}
where M¹, M²=Li. Na, K, Rb, Cs, and M¹ is not the same as M², and 0.05≦x≦0.95 and 2.0≦y≦6.0.

2. The mixture according to claim 1, wherein M¹=K and M²=Na.

3. The mixture according to claim 1, wherein 0.20≦x≦0.95.

4. The mixture according to claim 1, wherein 3.0≦y≦6.0.

5. The mixture according to claim 1, wherein M¹=K, M²=Na, 0.20≦x≦0.95 and 3.0≦y≦6.0.

6. The mixture according to claim 1, wherein M¹=K, M²=Na, 0.50≦x≦0.90 and y=4.0. 5.0 or 6.0.

7. A process for preparing the mixture according to claim 1, which comprises heating corresponding alkali metal sulfides with sulfur or corresponding alkali metal polysulfides with or without sulfur, under protective gas or under reduced pressure.

8. A process for preparing the mixture according to claim 1, which comprises reacting a solution of corresponding alkali metals in liquid ammonia with sulfur under protective gas.

9. The use of the mixture according to claim 1 as heat transfer or heat storage fluids.

10. A heat carrier or heat storage fluid which comprises a mixture according to claim 1.

11. A mixture of alkali metal polysulfides and alkali metal thiocyanates of the general formula
((M¹ₓM²₍₁₋ₓ₎)₂S_{y})ₘ (M³_{z}M⁴_{(1-z)}SCN)₍₁₋ₘ₎
where M¹, M², M³, M⁴=Na, K, Rb, Cs, and M¹ is not the same as M², M³ is not the same as M⁴, and 0.05≦x≦1, 0.05≦z≦1, 2.0≦y≦6.0, and In is the molar proportion, where 0.05≦m≦0.95.

12. The mixture according to claim 11, wherein M¹ and M³=K, and M² and M⁴=Na.

13. The mixture according to claim 11, wherein 0.20≦x≦1.

14. The mixture according to claim 11, wherein 3.0≦y≦6.0.

15. The mixture according to claim 11, wherein 0.20≦z≦1.

16. The mixture according to claim 11, wherein 0.20≦m≦0.80.

17. The mixture according to claim 11, wherein M¹ and M³=K, M² and M⁴=Na, 0.20≦x≦1, 0.20≦z≦0.95, 3.0≦y≦6.0 and 0.20≦m≦0.95.

18. The mixture according to claim 11, wherein M¹ and M³=K, M² and M⁴=Na, 0.50≦x≦1, 0.50≦z≦0.95, y=4.0, 5.0 or 6.0 and 0.33≦m≦0.80.

19. A process for preparing the mixture according to claim 11, which comprises co-melting corresponding alkali metal polysulfides and alkali metal thiocyanates.

20. The use of the mixtures according to claim 11 as heat transfer or heat storage fluids.

21. A heat transfer or heat storage fluid which comprises a mixture according to claim 11.

22. Mixtures of alkali polysulfides of composition (K₍₁₋ₓ₎Naₓ)₂ S_{z} with x=0 up to 1 and z=2.3 up to 3.5.

23. The use of the mixtures according to claim 22 as heat transfer or heat storage fluids.

24. A heat transfer or heat storage fluid which comprises a mixture according to claim 22.
